(19) United States
(12) Patent Application Publication
(10) Pub. No.: US 2017/0078744 A1
(43) Pub. Date: Mar. 16, 2017

(54) METHOD AND DEVICE TO MANAGE VIDEO CONTENT

(71) Applicant: Lenovo (Singapore) Pte. Ltd., New Tech Park (SG)

(72) Inventors: Russell Speight VanBlon, Raleigh, NC (US); Nathan J. Peterson, Durham, NC (US); John Carl Mese, Cary, NC (US); Arnold S. Weksler, Raleigh, NC (US)

(21) Appl. No.: 14/854,276

(22) Filed: Sep. 15, 2015

(51) Int. Cl. H04N 21/4402; H04N 21/647; H04N 21/45; H04N 21/442; H04N 21/4223

(52) U.S. Cl. CPC H04N 21/440263; H04N 21/44218; H04N 21/4223; H04N 21/4532; H04N 21/64738

(57) ABSTRACT

A method, computer program product and device are provided that determine a viewer characteristic of interest (COI) utilizing one or more processors and a sensor. The viewer COI is indicative of a relation between a viewer and a display. The method, computer program product and device manage a data rate, utilizing the one or more processors, based on the viewer COI and the one or more display attributes, the data rate representing a rate at which video content is conveyed to the display, the data rate corresponding to a discernible resolution.

### BACKGROUND

Embodiments of the present disclosure generally relate to methods and devices for managing video content streaming based on viewer characteristics of interest.

Today, a wide variety of devices are offered for displaying video content to users, such as televisions, laptop computers, desktop computers, tablet devices, smart phones and the like. The televisions and other video display devices vary in size, display technology, and resolution capability. For example, available televisions and other video display devices have the capability of displaying video content at various resolutions. However, depending upon individual circumstances, the human eye is not necessarily capable of distinguishing detail equal to the resolution of a television or other video display device. For example, factors that affect a viewer's ability to distinguish differences in resolution include the size of the display, the distance between the viewer and the display device and the nature of the content being displayed. Hence, when a viewer is positioned a certain distance from a display device, the viewer is no longer able to distinguish between different in resolutions. For example, a viewer sitting 10 feet away from a 40 inch television may not be able to distinguish the difference between 720 p and 1080 p resolution.

Further, a large portion of the video content presented today on display devices is conveyed from a content provider over a network in a streaming manner, such as video on demand. Network connections have a finite bandwidth that is often shared between various devices at an end point, such as in a home or business. The content provider seeks to stream the video content at a data rate sufficient to meet a resolution upper limit of the display device based on the capability of the display device. Consequently, portions of bandwidth for an individual user's account may be wasted in connection with providing high quality video content, even though a viewer may not be close enough to distinguish/appreciate the full quality/resolution of the video content presented on the display device.

A need remains for methods and devices that efficiently manage bandwidth usage for streaming video content and that overcome the foregoing and other disadvantages of conventional approaches.

### SUMMARY

In accordance with an embodiment, a method is provided that comprises determining a viewer characteristic of interest (COI) utilizing one or more processors and a sensor. The viewer COI is indicative of a relation between a viewer and the display. The method manages a viewer based data rate, utilizing the one or more processors, based on the viewer COI and the one or more display attributes. The viewer based data rate represents a rate at which video content is conveyed to a display, while the viewer based data rate corresponds to a discernible resolution.

The discernible resolution is less than a display resolution upper limit. The method further comprises determining a viewing distance to a viewer as the viewer COI, wherein the managing further comprises setting the viewer based data rate based on the viewing distance and a display size parameter. Additionally or alternatively, the determining operation may include capturing image frame data representing a viewer's face, detecting eye movement from the image frame data, and calculating, utilizing the processor, the gaze direction vectors from the eye movement.

Optionally, the method changes the viewer based data rate from a first viewer based data rate to a second viewer based data rate based on a distance to the viewer changing from a first distance to a second distance. The first viewer based data rate corresponds to a higher discernible resolution than associated with the second viewer based data rate, while the first distance is shorter than the second distance.

Additionally or alternatively, the method further comprises designating the viewer from a group of viewers who are located proximate to a reference point. The viewer being designated represents the closest viewer to the reference point from the group of viewers. Optionally, the method further comprises identifying non-viewers located proximate to the reference point based on viewer selection criteria. Optionally, the method further comprises streaming the video content over a network, determining a network utilization associated with the network, and performing the managing in response to the network utilization exceeding a threshold. The determining operation includes tracking movement of the viewer relative to a reference point and determining a gaze state of the viewer indicating whether the viewer is looking at the video content presented on a display. The managing operation reduces the viewer based data rate in connection with the viewer leaving a room. Optionally, the managing operation suspends delivery of the video content over a network in response to the viewer leaving the room.

In accordance with embodiments, a device is provided that comprises a processor, a display having one or more display attributes including a display size parameter, the display having a resolution upper limit, a sensor to determine a viewer characteristic of interest (COI) indicative of a relation between a viewer and the display, and a local storage storing program instructions accessible by the processor. Responsive to execution of the program instructions, the processor manages a viewer based data rate based on the viewer COI and the one or more display attributes. The viewer based data rate represents a rate at which video content is conveyed to the display. The viewer based data rate corresponds to a discernible resolution.

Optionally, the sensor represents a camera that collects image frame data. Optionally, the display represents a television and the discernible resolution corresponds to a resolution at which the video content displayed on the television. The processor sets the discernible resolution to be less than the resolution upper limit of the display. The display, processor, local storage and sensor are held in a common housing, the sensor located adjacent the display on a front face of the housing. The processor, sensor and local storage defined a video control device connected to the display, the video control device communicating with a content provider over a delivery network to manage the viewer based data rate.

In accordance with embodiments herein, a computer program product is provided comprising a non-signal computer readable storage comprising computer executable code to perform storing one or more display attributes for a display having a resolution upper limit, the one or more display attributes including a display size parameter, determining a viewer characteristic of interest (COI) utilizing one or more processors and a camera, the viewer COI indicative of a relation between a viewer and the display and managing a viewer based data rate, utilizing the one or more processors, based on the viewer COI and the one or more display attributes, the viewer based data rate representing a rate at which video content is conveyed to the display, the viewer based data rate corresponding to a discernible resolution.

Additionally or alternatively, the computer program product further comprises codes to store a resolution map defining a relation between display size parameter, viewing distance and discernible resolution, the discernible resolution being determined by applying the viewer COI and display attributes to the resolution map. The receiving operation includes one or more of identifying non-viewers based on one or more distinguishing characteristics; and ignored the non-viewers in connection with determining the viewer COI.

### BRIEF DESCRIPTION OF THE DRAWINGS

FIG. 1 illustrates a system for managing video content streaming in accordance with embodiments herein.

FIG. 2 illustrates a display as implemented in an environment in accordance with an embodiment herein.

FIG. 3 illustrates a resolution map that illustrates a relation between display size parameter, viewing distance and discernible resolution utilized in accordance with embodiments herein.

FIG. 4 illustrates a block diagram of a content provider and a content server formed in accordance with an embodiment herein.

FIG. 5 illustrates a block diagram of a video control device in accordance with embodiments herein.

FIG. 6 illustrates a process for managing video content streaming at a viewer based data rate in accordance with embodiments.

FIG. 7 illustrates a process for determining a viewer characteristic of interest in accordance with embodiments herein.

FIG. 8 illustrates an intelligent display device formed in accordance with an alternative embodiment.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

It should be clearly understood that the various arrangements and processes broadly described and illustrated with respect to the Figures, and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

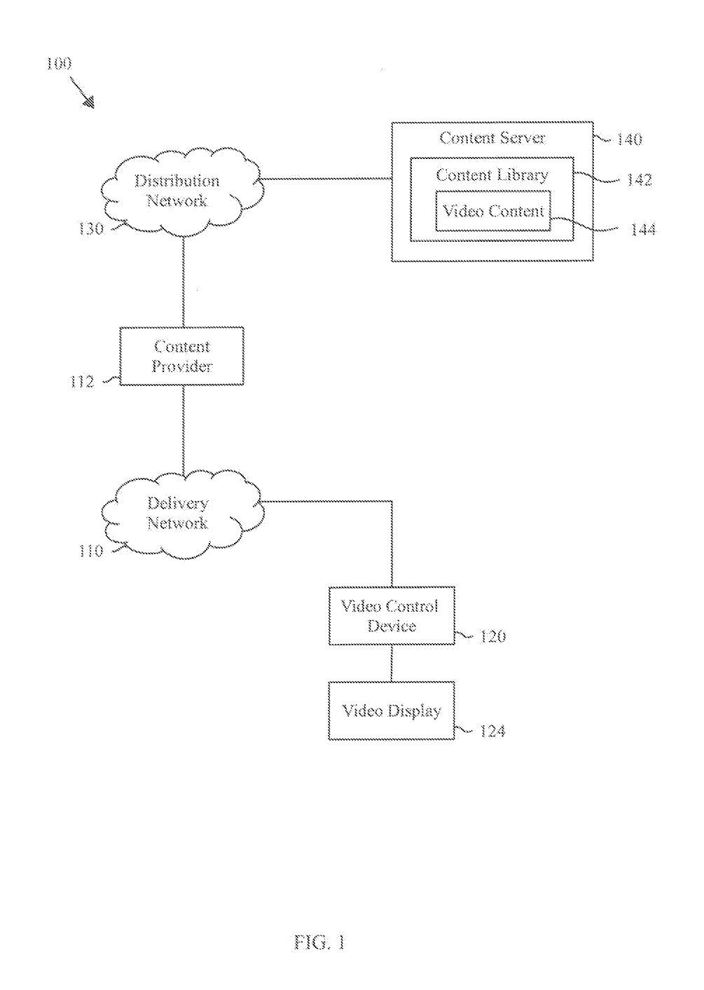

FIG. 1 illustrates a system 100 for managing video content streaming in accordance with embodiments herein.

The system 100 includes a content provider 112 coupled to a content server 140 through a distribution network 130. The content provider 112 also communicates bidirectionally with multiple video control devices 120 over a delivery network 110. In one embodiment, the video control device 120 is a set-top box, or a device such as a digital video recorder (DVR). One skilled in the art will appreciate that the delivery network 110 may connect a plurality of video control devices 120 to the content provider 112. The distribution network 130 connects a content server 140, content library 142, and content 144 to the content provider 112. In one embodiment, the content server 140 is a general-purpose server computer that supplies the content 144 stored in the content library 142 to the content provider 112. One skilled in the art will appreciate that the distribution network 130 may connect a plurality of content servers 140 to the content provider 112. The content provider 112 may maintain separate user accounts in connection with each video control device 122 provide video content in accordance with the corresponding user account information. Examples of content providers 112 include Netflix, the HBO NOW service, Hulu Plus, as well as television networks, cable providers and the like.

By way of example, the system 100 may represent a Video on Demand (VOD) system which allows users to select and watch/listen to video or audio content when they choose to, rather than having to watch at a specific broadcast time. The content provider 112 and video control device 120 may use Internet Protocol Television IPTV technology to bring video on demand to televisions and personal computers. Television VOD systems can stream content through a set-top box, a computer, an intelligent TV or other device, thereby allowing viewing in real time. Alternatively, the VOD system may download the content to a device such as a computer, digital video recorder (also called a personal video recorder) or portable media player for viewing at any time. The content provider 112 may be a cable- and telco-based television provider that offers VOD streaming, including pay-per-view and free content, whereby a user buys or selects a movie or television program, which begins to play on the television set almost instantaneously, or downloads to a DVR rented from the provider, or is downloaded onto a PC for viewing in the future. The content provider 112 may represent a video on demand service such as Netflix that uses a subscription model that requires users to pay a monthly fee to access a bundled set of content. Optionally, the content provider 112 may use an advertising-based model, where access is free for users, and the platforms rely on selling advertisements as a main revenue stream.

By way of example, video content may be conveyed over an Internet Protocol (IP) system using standard video codecs (at the content provider 112 and video control device 120) to reduce the video content to a bitstream (e.g., an MPEG transport stream), and then to an IP network to carry that bitstream encapsulated in a stream of IP packets. The bitstream may be encapsulated using some variant of the RTP protocol or another protocol. In connection with carrying video content over IP networks, certain quality of service requirements are fulfilled for use in customer based broadcast environments.

The delivery network 110 and the distribution network 130 may represent public communication networks that connect the content provider 112 to the video control device 120 and the content server 140. Embodiments herein also contemplate the use of network architectures. Examples of network architectures include the Public Switched Telephone Network (PSTN), a public packet-switched network carrying data and voice packets, a wireless network, and a private network. A wireless network includes a cellular network (e.g., a Time Division Multiple Access (TDMA), Code Division Multiple Access (CDMA), or Orthogonal Frequency Division Multiplexing (OFDM) network), a satellite network, and a wireless Local Area Network (LAN) (e.g., a wireless fidelity (Wi-Fi) network). A private network includes a LAN, a Personal Area Network (PAN) such as a Bluetooth network, a wireless LAN, a Virtual Private Network (VPN), an intranet, or an extranet. An intranet is a private communication network that provides an organization such as a corporation, with a secure means for trusted members of the organization to access the resources on the organization's network. In contrast, an extranet is a private communication network that provides an organization, such as a corporation, with a secure means for the organization to authorize non-members of the organization to access certain resources on the organization's network. The system also contemplates network architectures and protocols such as Ethernet, Token Ring, Systems Network Architecture, Internet Protocol, Transmission Control Protocol, User Datagram Protocol, Asynchronous Transfer Mode, and proprietary network protocols comparable to the Internet Protocol.

The system 100 comprises a video control device 120 and a video display 124 having one or more display attributes including a display size parameter, the display having a resolution upper limit. The video control device 120 determines a viewer characteristic of interest (COI) utilizing one or more processors and a sensor. The viewer COI is indicative of a relation between a viewer and the display. The video control device 120 manages a viewer based data rate, utilizing the one or more processors, based on the viewer COI and the one or more display attributes. The video based data rate represents a rate at which video content is conveyed to the display. The video based data rate corresponds to a discernible resolution. The discernible resolution is less than the resolution upper limit of the display.

For example, the video control device 120 determines a viewing distance between the viewer and the display as the viewer characteristic of interest, and sets the data rate based on the viewing distance and the display size parameter. The video control device 120 sets the video based data rate to correspond to a select resolution as the discernible resolution which is less than the resolution upper limit of the display. Examples of resolutions are standard 480 p resolution (e.g. 720 pixels in width by 480 pixels in height), high definition 720 p (e.g. 1280 pixels in width by 720 pixels in height), full high-definition 1080 p (e.g. 1920 pixels in width by 1080 pixels in height), and ultrahigh definition 2160 p (e.g. 3840 pixels in width by 2160 pixels in height). The video control device 120 changes the data rate from a first data rate to a second data rate based on a distance to the viewer changing from a first distance to a second distance. For example, the distance changes when the distance between the viewer and a reference point changes (e.g., the distance between the viewer and the display). The first data rate corresponds to a higher discernible resolution than associated with the second data rate, the first distance being shorter than the second distance.

Optionally, the video control device 120 designates the viewer from a group of viewers who are located proximate to the display. For example, the viewer being designated represents the closest viewer to the display from the group of viewers. Optionally, the system 100 identifying non-viewers located proximate to the display based on viewer selection criteria. Optionally, the video control device 120 streams the video content over a network, determines a network utilization associated with the network, and performs the managing operation in connection with the network utilization exceeding a threshold.

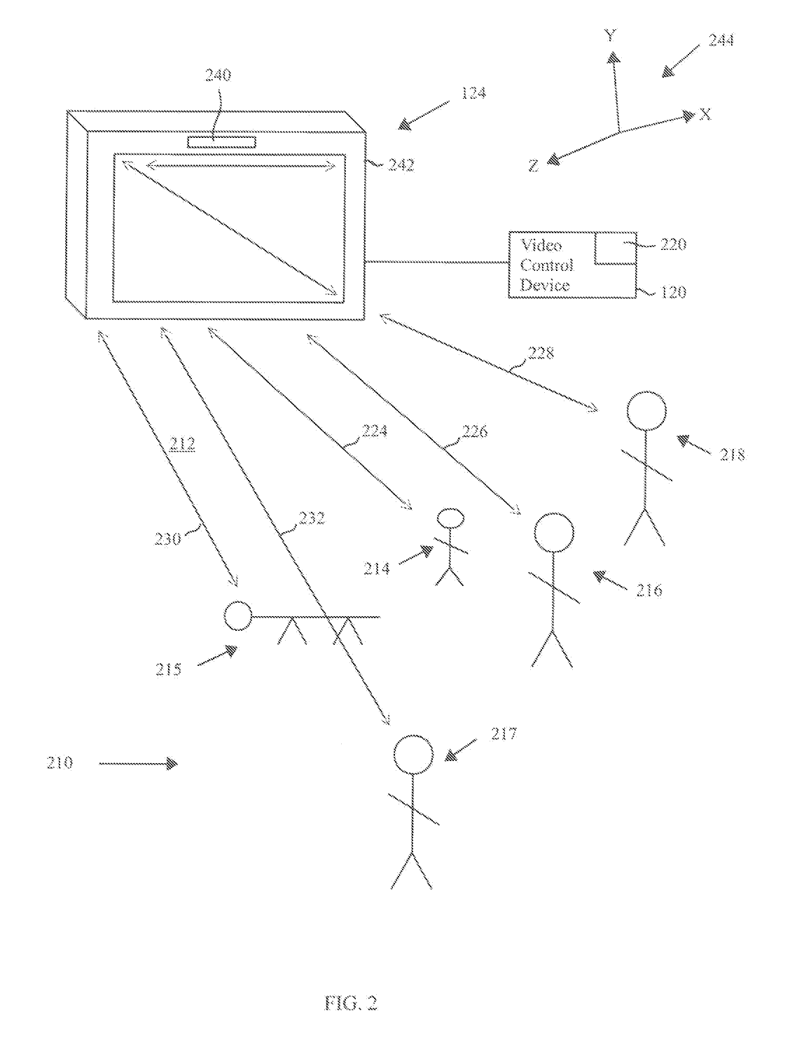

FIG. 2 illustrates the display 124 as implemented in an environment in accordance with an embodiment herein. The display 124 is connected (through wires or wirelessly) to the video control device 120. The display 124 may represent various types of electronic devices, such as a television, a computer monitor, a display within a desktop or laptop computer, a display within a tablet device, a display within a smart phone and the like. The video control device 120 includes one or more sensors 220 that is utilized to determine viewer characteristics of interest, such as measuring the viewing distance between a reference point (e.g., the display 124) and one or more viewers (generally denoted at 210). The viewers may include one or more individuals located within a viewing environment in which the display 124 is positioned. The individual viewers 214-218 are located various distances 224-232 from the display 124 or another reference point. As explained herein, the viewing distance is an example of one type of viewer characteristic of interest determined for one or more individual viewers 214-218. By way of example, potential viewers may be classified as “non-viewers” based on size, facial features or other distinguishing characteristics (for viewer selection criteria). For example, a child (as labeled at 214) or a pet (as noted at 215) may be identified as non-viewers and ignored in further determinations of characteristics of interest. In the example of FIG. 2, it may be determined that the individual viewer 218 is the controlling viewer, and as such the viewing distance 228 is utilized to calculate the discernible resolution. The controlling viewer may be determined in various manners. For example, the controlling viewer may be designated as a particular individual who is identified through distinguishing features, such as facial recognition, voice, size (e.g. adult versus child). Optionally, the controlling viewer may be designated as the closest individual to the display. The viewing distant is measured to the controlling viewer.

Optionally, the viewing distance may be determined as an average distance associated with all or a portion of the individual viewers in the environment 212. For example, the viewing distance may be determined as the average distance between the display 124 and a group of individual viewers (e.g., the first five, the closest 3, anyone sitting). Alternatively, the viewing distance may be determined as the average distance between the display 124 and all of the individuals present.

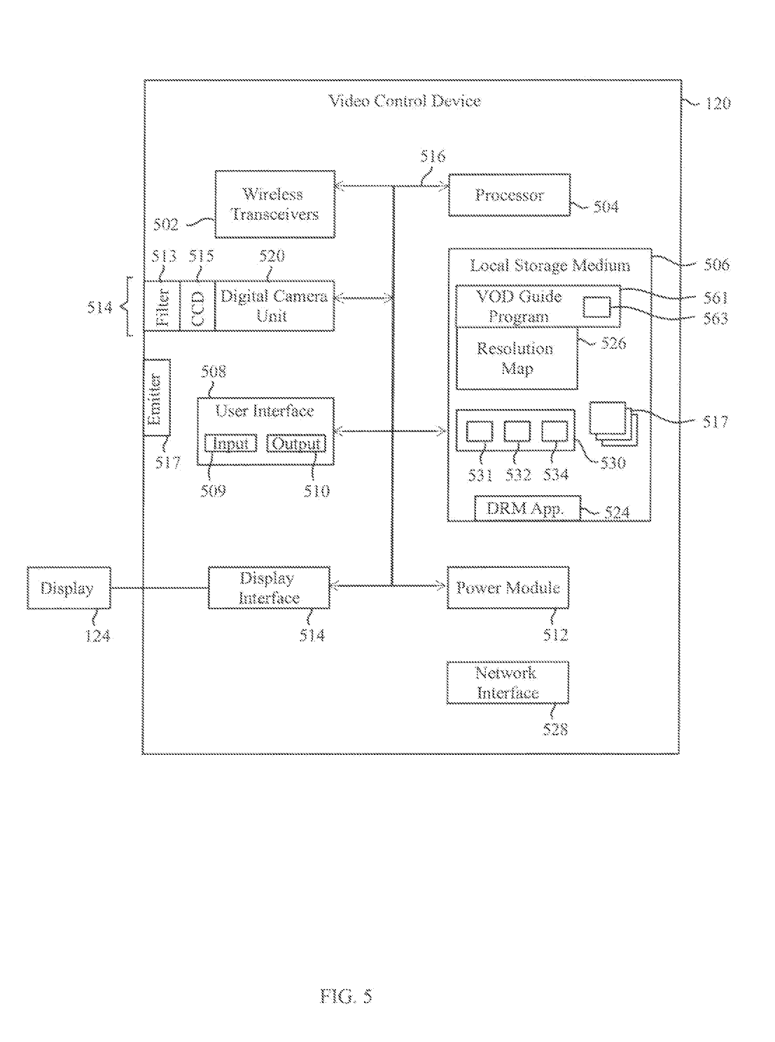

It is recognized that the location of the video control device 120 presented in FIG. 2 is merely an example and is not geographically limiting. For example, the video control device 120 may be positioned immediately adjacent the display 124, and/or mounted to the housing 242 of the display 124. As another example, the video control device 120 may be positioned remotely from the display 124, in which case the sensor 220 may collect position information within a reference coordinate system 244 for the reference point (e.g., display 124) and one or more individual viewers 214-218. For example, the video control device 120 may be treated as an origin within the reference coordinate system 244, with the location of the display 124 assigned a discrete position (e.g. an XYZ coordinates or in polar coordinates or otherwise). The location(s) of the individual viewer(s) 214-218 are also assigned discrete positions in the coordinate system. Once discrete positions are known for the display and viewers, the corresponding viewing distances may be determined by the one or more processors 504 (FIG. 5).

In the foregoing example, the viewing distance(s) is determined utilizing one or more sensors 220 located at the video control device 120. Optionally, the video control device 120 may be integrated into the display 124 and physically mounted within the housing 242 of the display 124. Additionally or alternatively, one or more sensors 240 may be located within the housing 242 of the display 124 in addition to or in place of sensor 220. The sensors 220, 240 collect information associated with a distance between the individual viewers 214-218 and the display 124, and such information is utilized as explained herein. The sensors 220, 240 may represent various types of still or video camera, detection units infrared sensors, motion detectors, ultrasound sensors and the like.

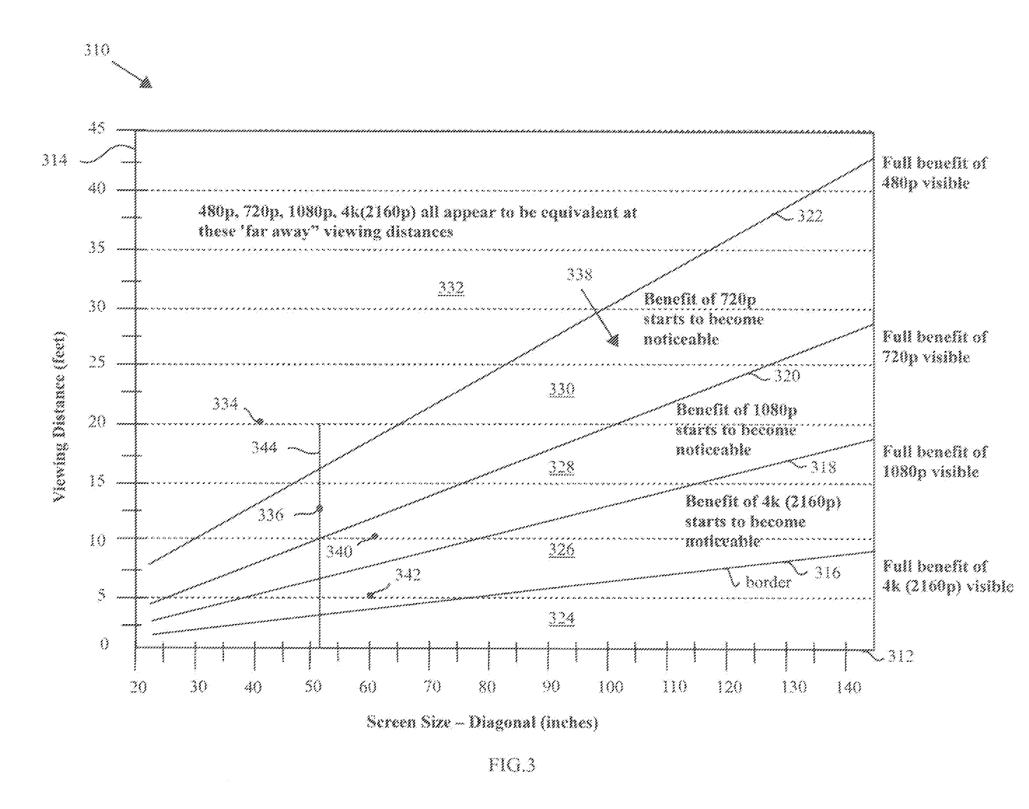

FIG. 3 illustrates a resolution map 310 that illustrates a relation between display size, viewing distance and discernible resolution utilized in accordance with embodiments herein. The resolution map 310 is utilized in connection with various embodiments for determining how to manage a viewer based data rate at which video content is conveyed to a display screen while maintaining a resolution on the display screen that is discernible to the viewer. As explained herein, the viewer based data rate is managed to avoid presenting video content at excessively high resolutions that are not discernible to the viewer.

The resolution map 310 plots display or screen size 312 along the horizontal axis and viewing distance 314 along the vertical axis. The display size parameter 312 may be measured in various manners. In the example of FIG. 3, the display size parameter 312 is measured diagonally between opposite corners of the display. The viewing distance 314 may be measured in various manners by the sensors 220, 240 (FIG. 2) and determined relative to various reference points. For example, the viewing distance 312 may be measured in three-dimensional space where the origin of a three-dimensional coordinate system is located at the sensors 220, 240 provided on or proximate to the display. Alternatively, the viewing distance 312 may be measured relative to a two-dimensional coordinate system (e.g. a top-down view), such as relative to the floorplan for a room in which the display is located.

The resolution map 310 includes numerous boundary lines 316, 318, 320 and 322 that separate visibility ranges 324 326, 328, 330 and 332. The visibility ranges 324-332 represent areas in which a viewer is able to discern or realize all or at least a majority of the benefit/visibility of a particular resolution. For example, in the visibility range 332, the resolution offered by most displays (e.g. televisions) appeared to be equivalent, such that the viewer is unable to discern a difference in the resolution of a display exhibiting a resolution of 480 p, as compared to better resolutions, such as 720 p, 1080 p, or 2160 p. As a further example, with respect to particular exemplary data points, as noted at mark 334, when a user is located 20 feet away from a 40 inch television, the user is unable to distinguish a difference between the various noted resolutions.

The boundary line 322 indicates a transition point at which a viewer is able to recognize the full benefit of the 480 p resolution. The boundary lines 316-322 generally represent lines of transition. The boundary lines 316-322 are not hard transition points. Instead, it is recognized that a level to which details on a display are distinguished, gradually changes while progressing across the resolution map 310. When crossing the boundary line 322 in the direction of arrow 338, at least the resolution 720 p is noticeable to a viewer relative to the lower resolution of 480 p. As noted at mark 336, when a user is 12 feet away from a 52 inch television, the user is able to distinguish a difference between a resolution of 480 p, and a resolution of 720 p. The visibility range 330 represents a range in which the resolutions of 720 p or greater begin to become distinguishable from 480 p resolution to viewers. Within the visibility range 330, the viewer is unable to distinguish differences between resolutions at and above 720 p. Generally, within the visibility range 330, resolutions at or above 720 p are not discernible from one another. As the combination of screen size and viewing distance transitions across the visibility range 330 from left to right and from top to bottom, the degree to which a user is able to discern the corresponding resolution and slightly higher improves until reaching the boundary line 320. At the boundary line 320, the user is realizing the full benefit of a resolution of 720 p (e.g. the visibility of the 720 p resolution is fully apparent to a normal viewer). Upon crossing the boundary line 320 from visibility range 330 into visibility range 328, the viewer now becomes able to being distinguishing the difference between the 720 p resolution and the 1080 p resolution. For example, at mark 340, the viewer is able to distinguish at least one level of the difference in resolution between 1080 p and 720 p when located 10 feet away from a 60 inch display screen. Within the visibility range 328, the viewer is unable to distinguish the difference between resolutions of 1080 p and higher.

As the combination of screen size and viewing distance transitions across the visibility range 328 from left to right and top to bottom, the degree to which a user is able to discern the corresponding resolution of 1080 p improves until reaching the boundary line 318. At the boundary line 318, the user is realizing the full benefit of the 1080 p resolution. Upon crossing the boundary line 318 from the visibility range 328 into the visibility range 326, the viewer now begins to be able to distinguish the differences between 1080 p resolution and 2160 p resolution. For example, at mark 342, the viewer is able to distinguish the difference in resolution between 1080 p and 2160 p when 3 feet away from a 60 inch display screen. As the combination of screen size and viewing distance transitions across the visibility range 326 from left to right and top to bottom, the degree to which a user is able to discern the corresponding resolution improves until reaching the boundary line 316. At the boundary line 316, the user is realizing the full benefit of a resolution of 2160 p. The visibility range 324 corresponds to resolutions above 2160 p.

As a further example, a vertical line 344 is illustrated that corresponds to a 52 inch display screen. When viewing a 52 inch display screen, the user is unable to distinguish the difference between the various noted resolutions when 15 feet or more away from the display screen. Upon moving into the range of 5 to 10 feet away from the 52 inch display screen, the viewer then becomes able to distinguish the difference between resolutions up to 720 p. Hence, when standing 10 to 15 feet away from a 52 inch screen, the user is able to distinguish the difference between a 480 p resolution and a 720 p resolution. When the viewer moves to within approximately 6 to 10 feet away from the 52 inch screen, the user then becomes able to distinguish the difference between resolutions up to 1080 p to varying levels depending on how close the viewer is. However, as noted above, the user is unable to distinguish the difference between resolutions above 1080 p when standing 6 to 10 feet away from the screen. When the user moves to within 3 to 6 feet of the 52 inch screen, the user then becomes able to distinguish the difference between 2160 p resolution and lower resolutions.

The resolution map 310 and discussion herein relates to an average or model viewer's ability to distinguish between different resolutions. It is recognized that individuals may have better or poor eyes, and as such the boundary lines and visibility ranges adjust accordingly. Optionally, viewers may set up individual resolution maps tailored to their particular vision.

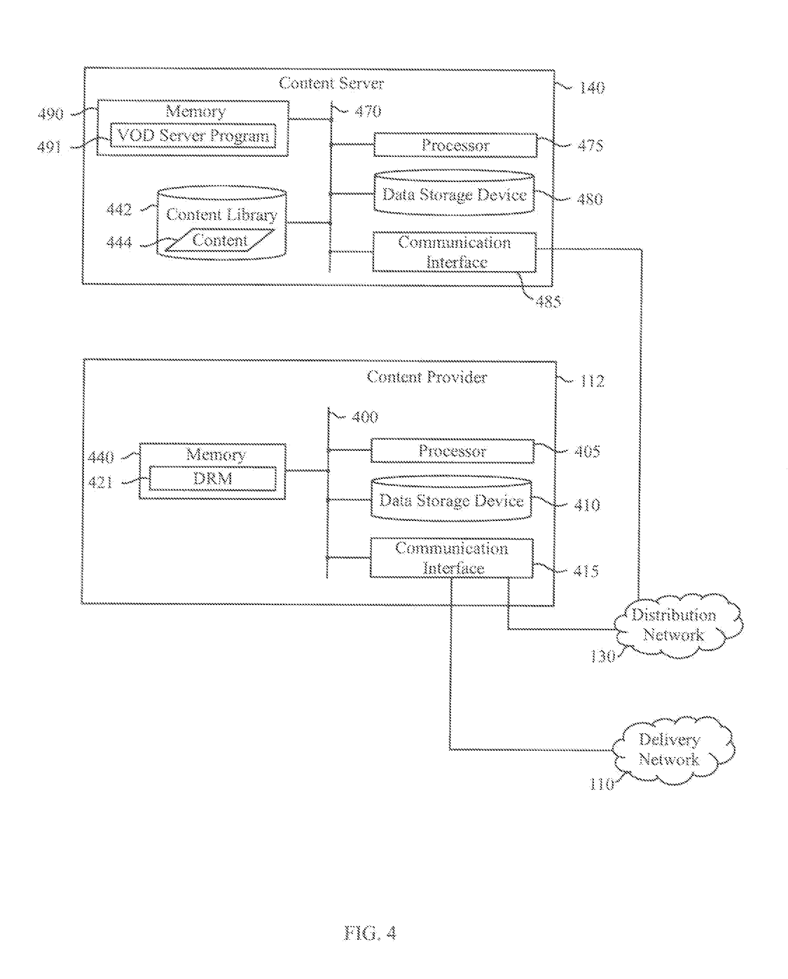

FIG. 4 illustrates a block diagram of the content provider 112 and the content server 140 formed in accordance with an embodiment herein. The content provider 112 includes one or more processors 405, a bus 400 that is a communication medium that connects the processor 405, data storage device 410 (such as a Serial ATA (SATA) hard disk drive, optical drive, Small Computer System Interface (SCSI) disk, or the like), communication interface 415, and memory 440 (such as Random Access Memory (RAM), Dynamic RAM (DRAM), or the like). The communication interface 415 transmits and receives the video content and other data between the content provider 112 and the video control device 120 via the delivery network 110, and between the content provider 112 and the content server 140 via the distribution network 130.

The processor 405 performs the disclosed methods by executing program instruction stored in the memory 440. The memory 440 may include operating system, administrative, and database programs that support the programs described herein. The memory 440 stores a data rate management (DRM) module 421 that includes program instructions to direct the processor 405 to communicate with the display control device 120 to manage the viewer based data rate at which the video content is conveyed to the display control device 120. When the processor 405 performs the disclosed methods, it stores data and video content in the memory 440 or data storage device 410.

The content server 140 shown in FIG. 4 includes a bus 470 that is a communication medium that connects a processor 475, data storage device 480 (such as a Serial ATA (SATA) hard disk drive, optical drive, Small Computer System Interface (SCSI) disk, or the like), communication interface 485, memory 490 (such as Random Access Memory (RAM), Dynamic RAM (DRAM), or the like), and content library 442. The communication interface 485 transmits and receives data between the content server 140 and the content provider 112 via the distribution network 130.

The processor 475 performs the disclosed methods by executing the sequences of operational instructions that comprise each computer program resident in, or operative on, the memory 490. The memory 490 may include operating system, administrative, and database programs that support the programs disclosed in this application. In one embodiment, the memory 490 includes a VOD server program 491. The VOD server program 491 communicates with the content provider 112. The VOD server program 491 receives requests for the content 444 from the content provider 112 and sends the content 144 to the content provider 112 in response to those requests. When the processor 475 performs the disclosed methods, it stores intermediate data and video content in the memory 490 or data storage device 480.

FIG. 5 illustrates a block diagram of the video control device 120, which includes components such as one or more wireless transceivers 502, one or more processors 504 (e.g., a microprocessor, microcomputer, application-specific integrated circuit, etc.), one or more local storage (also referred to as a memory portion) 506, a user interface 508 which includes one or more input devices 509 and one or more output devices 510, a power module 512, a camera 520, a display interface 514 and a network interface 528. The components can be operatively coupled to one another, and can be in communication with one another, by way of one or more internal communication links 516, such as an internal bus. In the embodiment of FIG. 5, the emitter 517 and camera 520 collectively represent a sensor.

The processor 504 performs the disclosed methods by executing the sequences of operational instructions that comprise each computer program resident in, or operative on, the memory 506. The memory 506 may include operating system, administrative, and database programs that support the programs disclosed in this application. In one embodiment, the configuration of the memory 506 of the video control device 120 includes a VOD guide program 561. The VOD guide program 561 directs the processor 504 to communicate with the content provider 112. The VOD guide program 561 allows the user to select and request various video content and display the video content on the display 124. When the processor 504 performs the disclosed methods, it stores intermediate data and video content in the memory or storage 506.

The housing 512 of the video control device 120 holds the processor(s) 504, local storage 506, user interface 508, the camera 520 and other components. The camera 520 collects data in connection with one or more viewer characteristics of interest (COI). The camera 520 may represent a still or video camera that collects still or video image frames. A lens 514 is optically and communicatively coupled to the camera 520. The lens 514 may be mounted at various locations on the housing 512. Optionally, multiple lenses 514 may be positioned at various distributed positions within, or about the perimeter of the housing 512. The camera 520 may represent various types of still or video cameras, detection units and the like. The camera 520 may further include one or more filters 513 and one or more detectors 515, such as a charge coupled device (CCD). The detector 515 may be coupled to a local processor within the camera 520 that analyzes image frame data captured. The camera 520 may include one or multiple combinations of emitters, detectors and lens. For example, an array of two or more detector/lens combinations may be spaced apart from one another on the housing 512. When multiple detectors/lens are used, each detector/lens combination may be oriented in at least partially different directions, such that the fields of view of the respective detector/lens combinations encompass different areas. One or more emitters 517 may be provided within or separate from the lens 514 and detector 515.

Additionally or alternatively, the camera 520 may collect data related to a viewer COI other than image frames. For example, the camera 520 may represent one or more infrared (IR) light emitting diode (LED) based-camera devices. For example, one or more IR-LED emitters 317 may be used to illuminate the field of view with one or more select wavelengths of light (e.g., 880 nm). A high pass filter (HPF) 513 element is located with the lens 514 such that the HPF 513 element passes infrared light with a select wavelength (e.g., 800 nm). The IR-LED emitter 517 and detector 515 represent one type of camera that collects data related to viewer COI.

The input and output devices 509, 510 may each include a variety of visual, audio, and/or mechanical devices. For example, the input devices 509 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 510 can include a visual output device such as a liquid crystal display screen, one or more light emitting diode indicators, an audio output device such as a speaker, alarm and/or buzzer, and a mechanical output device such as a vibrating mechanism. The display may be touch sensitive to various types of touch and gestures. As further examples, the output device(s) 510 may include a touch sensitive screen, a non-touch sensitive screen, a text-only display, a smart phone display, an audio output (e.g., a speaker or headphone jack), and/or any combination thereof. The user interface 508 permits the user to select one or more of a switch, button or icon in connection with normal operation of the video control device 120.

The local storage 506 may encompass one or more memory devices of any of a variety of forms (e.g., read only memory, random access memory, static random access memory, dynamic random access memory, etc.) and can be used by the processor 504 to store and retrieve data. The data that is stored by the local storage 506 can include, but need not be limited to, operating systems, applications, streaming video content, resolution maps, viewer COIs, display attributes and informational data. Each operating system includes executable code that controls basic functions of the communication device, such as interaction among the various components, communication with external devices via the wireless transceivers 502, the network interface 528 and/or the display component interface 514, and storage and retrieval of applications and data to and from the local storage 506. Each application includes executable code that utilizes an operating system to provide more specific functionality for the communication devices, such as file system service and handling of protected and unprotected data stored in the local storage 506.

As explained herein, the local storage 506 stores various content, including but not limited to video content 517, one or more resolution map 526, viewer characteristics of interest 530 such as viewing distance 531, position data 532, line of sight (LOS) data 534, lighting level, and the like. The video content 517 may represent various types of graphical and video content including audio content.

Other applications stored in the local storage 506 include various application program interfaces (APIs). Additionally, the applications stored in the local storage 506 include a data rate management (DRM) application 524 for facilitating the management of the resolution of video content displayed on the display 124. For example, the DRM application 524 may communicate with the DRM module 421 (FIG. 4) at the content provider to set and change the data rate. The DRM application 524 is preferably activated by default upon start-up of the video control device 120, and can be activated or disabled via input devices 509 of the user interface 508. In one embodiment, the DRM application 524 may be activated when the video control device 120 sends a request over the network for video content (e.g., video on demand). The DRM application 524 includes program instructions accessible by the processor 504 to direct the processor 504 to implement the methods, processes and operations described herein, and illustrated and described in connection with the Figures.

In accordance with embodiments herein, the DRM application 524 may determine viewer COIs by analyzing image frame data 530 captured by the camera 520. For example, to identify a controlling viewer, the DRM application 524 may detect facial features, eye movement, line of sight of the eyes and the like. In accordance with embodiments herein, the camera 520 collects a series of image data frames 530 associated with the scene 526 over a select period of time. For example, the camera 520 may begin to capture the image data frames 530 when the application 524 senses movement of the room. Image frame data 530 may be collected for a predetermined period of time, for a select number of frames or based on other data collection criteria. For example, the camera 520 may include capturing image frame data which may represent a viewer's face with the camera, detecting eye movement from the image frame data and calculating, utilizing the processor, the gaze direction vectors from the eye movement to determine whether the viewer is gazing at the display.

The processor 504, under control of the application 524, analyzes one or more image data frames 530, to detect a position of one or more viewers, viewer's faces, eye movement, gaze, direction, etc. The viewer position is designated with respect to a coordinate reference system (e.g. an XYZ reference point in the scene).The processor 504 records, in the local storage 506, position data 532 indicating a location of one or more viewers.

Optionally, the processor 504, under the control of the application 524, may determine the line of sight associated with one or more viewers, such as to identify who is watching a television. The LOS data 534 may represent a gaze direction vector defined with respect to a coordinate system. For example, the gaze direction vector may be defined with respect to a polar coordinate system, where a reference point and origin of the polar coordinate system are located at a known position.

The power module 512 preferably includes a power supply, such as a battery, for providing power to the other components while enabling the video control device 120 to be portable, as well as circuitry providing for the battery to be recharged. The component interface 514 provides a direct connection to other devices, auxiliary components, or accessories for additional or enhanced functionality, and in particular, can include a USB port for linking to a user device with a USB cable.

Each transceiver 502 can utilize a known wireless technology for communication and receiving wireless streaming video content. Exemplary operation of the wireless transceivers 502 in conjunction with other components of the video control device 120 may take a variety of forms and may include, for example, operation in which, upon reception of wireless signals, the components of video control device 120 detect communication signals and the transceiver 302 demodulates the communication signals to recover incoming information, such as video content, transmitted by the wireless signals.

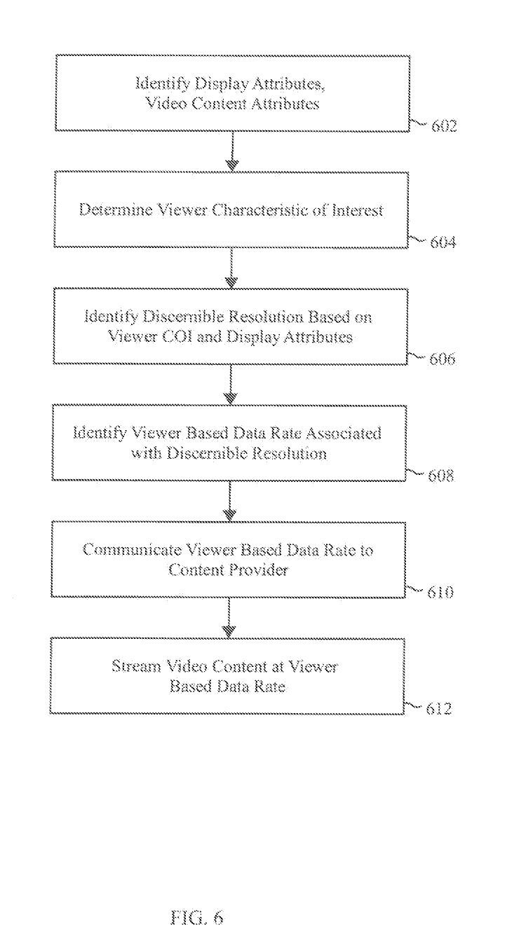

FIG. 6 illustrates a process for managing video content streaming at a viewer based data rate in accordance with embodiments. The operations of FIG. 6 are carried out by one or more processors 405, 504 (FIGS. 4 and 5) in response to execution of program instructions, such as in the DRM module 421 and DRM application 524, and/or other applications stored in the local storage. At 602, the method identifies one or more display attributes associated with the display, such as the display size parameter. Optionally, at 602, video content attributes may also be identified. For example, video content attributes may identify information regarding the nature of the video content that may be used in connection with determining the discernible resolution and viewer based data rate. For example, children's cartoons may be designated to have a low priority, in the event that bandwidth usage becomes a concern. For example, when multiple resources compete for bandwidth, a low priority attribute may be utilized to further reduce the resolution (and thus the data rate) to be used when streaming children's cartoons or other low priority content. As another example, video content may have an attribute designating the content as three-dimensional (3-D) content, HD content, ultra HD content and the like. A 3-D, HD or ultra HD content attribute may be utilized as an indicator to than may otherwise be chosen, such as when the display attributes and viewer characteristic of interest may fall on or near a border distinguishing transition points between different visibility ranges.

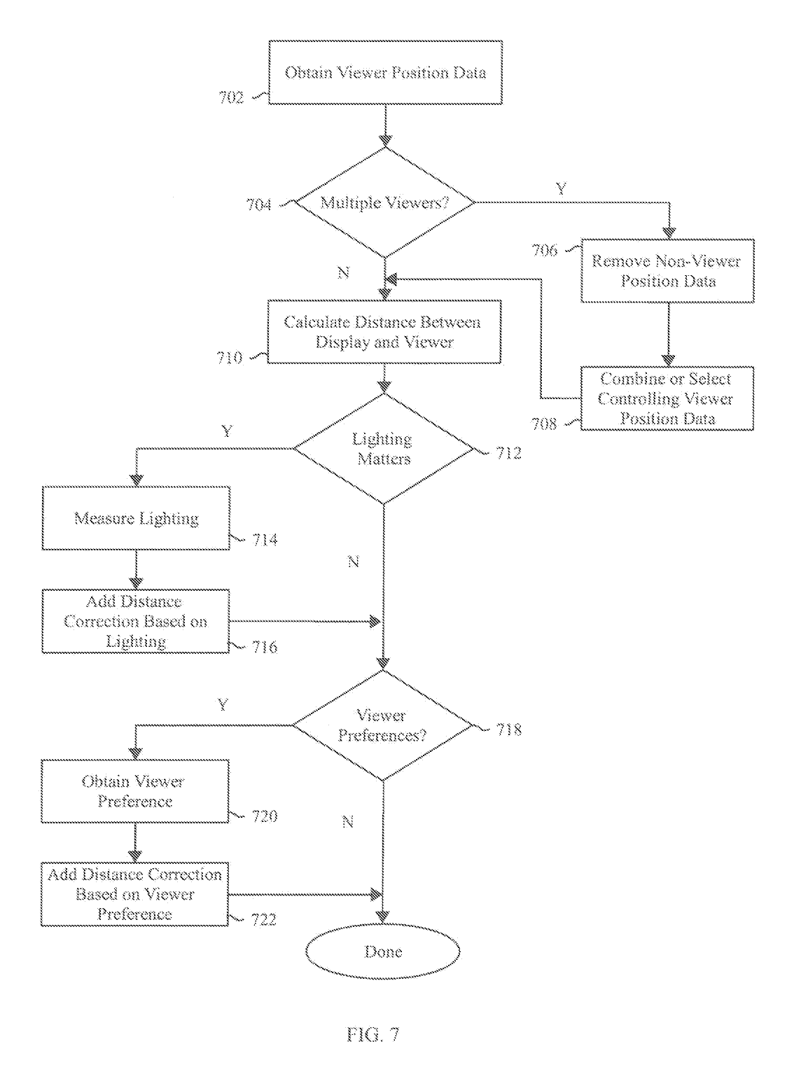

At 604, the viewer characteristic of interest is determined by the camera and one or more processors. For example, the camera 520 (FIG. 5) and processor 504 may measure a viewing distance between a reference point (e.g., the display) and one or more viewers. The determination at 604 may represent a simple distance measurement based on various technologies. As explained below in connection with FIG. 7, the determination of the viewer characteristic of interest may utilize more complex analysis, such as to disqualify individuals as non-viewers (e.g. children, pets), factoring in lighting, factoring in individual viewer preferences and the like.

At 606, the method identifies a discernible resolution based on the viewer COI and display attributes. For example, the resolution map 526 in FIG. 5 (or 310 in FIG. 3) may be accessed. The viewing distance (determined at 604 as the viewer characteristic of interest) and the screen size (identified as a display attribute at 602) are used to identify a point in the resolution map 310. Based on the point of intersection between the viewing distance and screen size, a discernible resolution is identified. For example, a display may have display attributes of a 52 inch size and a resolution upper limit of 1080 p. At 606, the process may determine that the viewer is located 12 feet away from the display (corresponding to mark 336 in FIG. 3). Accordingly, the process would identify as a discernible resolution of 720 p which does not correspond to the resolution upper limit (e.g. 1080 p in the present example) of the display. As another example, a display may have display attributes of a 60 inch diagonal size and a resolution upper limit of 2160 p. At 606, the process may determine that the viewer is standing 5 feet away from the display (corresponding to mark 342 in FIG. 3). Accordingly, the process would identify as a discernible resolution of 1080 p which does not correspond to the resolution upper limit of the display in the present example. As yet a further example, when a user is 10 and feet away from a display having display attribute of a 60 in diameter and a resolution upper limit of 1080 p, the process may determine that the discernible resolution (as noted at mark 340 within visibility range 328) corresponds to the resolution upper limit of the display.

At 608, the method identifies a viewer-based data rate associated with the discernible resolution. The term viewer based data rate, as used throughout, refers to “viewer based” as the data rate is not based on the technical capabilities of the display or video control device or any other hardware. Instead, the “viewer based” data rate is derived from the discernible resolutions based on a viewer characteristic of interest such as the distance between the viewer and a reference point (e.g., the display). The viewer based data rate may be determined in various manners, such as based on the components being used, type of network connection and the like. Various factors may affect the viewer based data rate that is appropriate to stream video content in a manner to achieve a particular resolution, namely the discernible resolution identified above. By way of example, the viewer based data rate is based in part on the bit rate associated with the video content. For example, video may be encoded at a low or a high bit rate, regardless of the resolution at which the video content is to be displayed. Another factor that affects the viewer based data rate concerns the nature of the content server from which the video content is streamed. The content server plays a role in the quality of the streaming video content and quality will vary depending on a degree to which the content server is busy. Another factor that affects the data rate concerns the type of protocol being used for streaming. There are different protocols that may be used in connection with streaming video content, where each protocol may have a different data rate associated there with. By way of example only, at 608, the method may determine that a 10 Mbps data rate is appropriate to stream video content in a manner that is able to be displayed with a resolution of 1080 p.

In accordance with at least one embodiment, the VOD guide program 561 may store a table associating various discernible resolutions with corresponding viewer based data rates.

Next, at 610, the viewer based data rate is communicated to the content provider. At 612, the content provider 112 and video control device 120 interact to initiate streaming of video content at the viewer based data rate.

The operations at 604-612 of FIG. 6 may be continuously repeated throughout a streaming process for a select video content (e.g. a television program, movie and the like). By continuously repeating the operations at 604-612, the method is able to track when a viewer moves and track changes in the viewing distance. When a viewer moves, the change in the viewing distance is determined at 604, a new discernible resolution is identified at 606, a new viewer based data rate is identified at 608 and communicated to the content provider at 610, thereby managing change in the viewer based data rate by tracking viewer movement. For example, the operations of FIG. 6 may determine and manage change in the viewer based data rate from a first viewer based data rate to a second viewer based data rate when a distance between the viewer and the reference point changes from a first distance to a second distance. With reference to the resolution map 310 of FIG. 3, for a 60 inch television, it may be assumed that the user is initially positioned 5 feet from the display (mark 342) which corresponds to a higher discernible resolution (e.g. 2160 p). When the user moves further away from the TV (e.g. to the mark 340, corresponding to 10 feet away) the process changes the viewer based data rate from the first viewer based data rate (associated with the higher discernible resolution of 2160 p) to a second lower viewer based data rate (associated with a lower discernible resolution of 1080 p). As a further example, by repeating the operations at 604-612, the data rate may be reduced with a viewer leaves a room or scene in front of the display.

In the foregoing example, the viewer based data rate is determined at the video control device 120. Optionally, the viewer based data rate may be identified by the content provider 112. For example, the operations at 608 and 610 may be modified such that the viewer based data rate may be identified based upon an exchange of information between the video control device 120 and the content provider 112. For example, the video control device 120 may provide the discernible resolution over the delivery network 110 to the content provider 112. In response thereto, the content provider 112 may identify the corresponding viewer based data rate, taking into account various factors that will result in a bit rate sufficient to provide the discernible resolution.

FIG. 7 illustrates a process for determining a viewer characteristic of interest in accordance with embodiments herein. For example, the process of FIG. 7 may be implemented in connection with the operation at 604 in FIG. 6. The operations of FIG. 7 are carried out by one or more processors in response to execution of program instructions, such as in the DRM module 421 and DRM application 524, and/or other applications stored in the local storage.

At 702, the camera 520 and/or sensor 220, 240 and one or more processors 504 obtain viewer position data. At 704, the method determines whether multiple viewers are present. For example, the position data may be analyzed to determine whether position data is returned for multiple individual users. Additionally or alternatively, the camera 520 and/or sensors 220, 240 or a separate sensor may be utilized to identify whether multiple viewers are present. When multiple viewers are present, flow moves to 706. Otherwise flow continues to 710. At 706, the process determines whether non-viewers exist that could be removed. For example, the camera 520 and/or sensors 220, 240 may collect additional viewer attributes, such as information concerning the size of viewers, facial characteristics of viewers and the like. One or more thresholds may be applied at 706 to the viewer attributes information. The method further comprising identifying non-viewers located proximate to the display based on viewer selection criteria. When a viewer is identified to be too small, or identified to represent a pet or other animal, the related viewer position data is deleted or otherwise ignored. Additionally or alternatively, at 706, the viewer data collected by the camera 520 and/or sensors 220, 240 may be analyzed utilizing various conventional facial recognition algorithms to identify one or more specific viewers who are designated as the control viewer(s). Additionally or alternatively, at 706, the data collected by the camera 520 and/or sensors 220, 240 may be compared to stored images or other prerecorded information regarding individual viewers to identify specific viewers who are designated as the control viewer(s). Viewer position data that is not associated with the control viewer(s) is deleted or otherwise ignored.

At 708, the position data for the remaining viewers may be combined, such as through averaging. For example, the positions of multiple remaining viewers may be combined to form a reference position to which the viewing distance is to be calculated. Additionally or alternatively, at 708, the position data for one of the controlling viewers may be selected. For example, the distance to the closest controlling viewer may be selected. Alternatively, the distance to the controlling viewer furthest from the display may be selected. Alternatively, a homeowner or other designated individual may be selected as the controlling viewer (e.g. based on the facial recognition analysis or comparison to pre-stored images. At the conclusion of 708, position data for a controlling viewer is returned to 710.

At 710, the method calculates the distance between the reference point (e.g., display) and the position data associated with the controlling viewer to derive a viewing distance. In accordance with at least one embodiment, the process may end at 710 and the viewing distance returned for subsequent use in the process of FIG. 6. Alternatively, additional factors may be considered to provide further refinements to the viewing distance. FIG. 7 illustrates examples of additional factors, namely lighting and viewer preferences. Although, it is understood that other factors may be utilized in place of or in addition to lighting and viewer preferences to further adjust the viewing distance. It is also recognized that lighting and viewer preferences, as well as other factors, may be accounted for in other manners, not simply through refinement of the viewing distance.

At 712, the method determines whether lighting should be factored in to the viewing distance. If so, flow moves to 714. Otherwise, flow moves to 718. At 714, the method measures a level of lighting in the area surrounding the display 124. For example, the sensor 220, 240 may measure the lighting level. Alternatively, a separate lighting sensor may be utilized to measure the lighting level. At 716, the method analyzes the measured lighting level and provides a viewing distance correction based thereon. For example, in low light conditions, the viewing distance may be increased by a predetermined amount. For example, in a low light conditions, the method may treat the viewer as if located a distance from the display greater than the actual measured viewing distance. In well-lit conditions, the viewing distance may be maintained without change or reduced.

At 718, the method determines whether viewer preferences should be factored into the viewing distance. If so, flow moves to 720. Otherwise, the process ends and returns to FIG. 6. At 720, the method obtains viewer preferences, such as the viewer preference information stored in the local storage 506 (FIG. 6). For example, a viewer may record a preference that regardless of the actual distance between the viewer and the display, the maximum viewing distance may be set to an upper limit (e.g. 15 feet).

Optionally, the viewer preference may relate to dynamic conditions in the room, such as when a viewer leaves the room, when the viewer enters the room, and the like. For example, when a viewer leaves the room, it may be desirable to maintain the pre-existing discernible resolution. Alternatively, when a viewer leaves the room, it may be desirable to substantially reduce the discernible resolution (e.g., reduce the data rate), in order to render bandwidth available for other uses. As a further example, it may be desirable to suspend delivery of the video content over a network to display when the viewer leaves the room. As a further option, it may be desirable to cease display of the video content entirely and only continue to display the audio content associated there with. At 722, the viewing distance is revised based on the viewer preferences. Thereafter, the process of FIG. 7 and flow returns to FIG. 6.

Embodiments herein are described as managing the data rate continuously throughout operation. For example, the data rate may be continuously updated through streaming video content. Optionally, the operations of FIGS. 6 and 7 may be performed at select points in time such as at the beginning of a program or other defined segment of video content. For example, the operations of FIGS. 6 and 7 may be formed one per video content segment, such as when a movie, television program, or other segment of video content is selected or initially started. Hence, at the beginning of a movie or other program, the viewing distance may be determined and a corresponding data rate communicated to the content provider. Once an initial data rate is assigned, the content provider may stream the entire program at the initially assigned data rate. Optionally, the operations of FIGS. 6 and 7 may be performed when a display device is turned on, without regard for a particular program of video content.

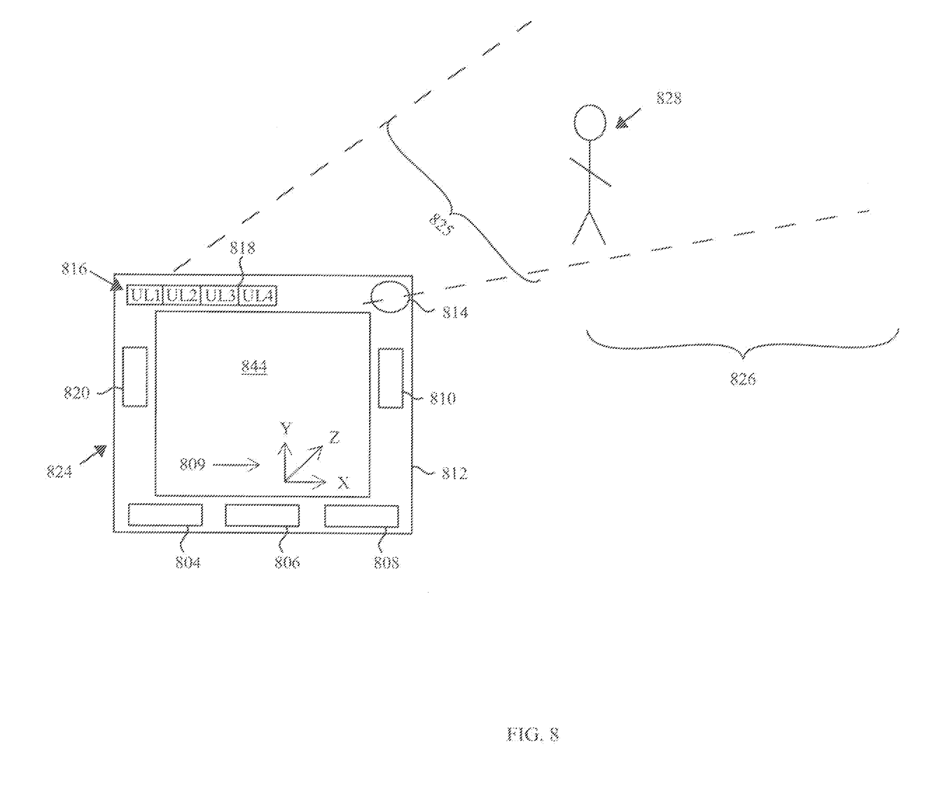

FIG. 8 illustrates an intelligent display device 824 formed in accordance with an alternative embodiment. For example, the intelligent display device 824 may represent an IPTV, a smart TV or otherwise. The intelligent display device 824 includes a housing 812 having a front face on which the display 844 is presented. Within the housing 812, various electronic components are provided, such as but not limited to the components described hereafter. The intelligent display device 824 includes, within the housing 812, a sensor array 816, an acoustic data collector 820, one or more processors 804, memory 806, a graphical user interface 808, a camera unit 810, a lens 814 and a display 844. Optionally, the sensor array 816 and lens 814 may be combined and utilized with the camera unit 810 as explained herein. Optionally, the lens 814 may be omitted entirely in favor of an alternative camera structure. In addition or alternatively, the sensor array 816 may represent a sensor array (also referred to herein as a sensor array 816) that is operated in connection with the acoustic data collector 820 as explained hereafter.

In the embodiment of FIG. 8, the intelligent display device 824 may utilize one or more cameras as described in connection with FIGS. 1-7 to collect viewer position data. Additionally or alternatively, the intelligent display device may utilize, as the camera, a sensor array 816, such as an acoustic transceiver array, that directly derives range information associated with one or more viewers. The range information may then be used directly as viewing distances. When range information is directly derived by a sensor array 816, the system and method no longer need to first determine position data associated with viewers and display position data, and then calculate viewing distances between the position data. Instead, the sensor array 816 may directly determined the viewing distance as range information. While the sensor array 816 is derived as being integrated into the housing of the intelligent display device 824, optionally, the sensor array 816 may be physically separate from the housing, but instead merely located proximate to the intelligent display device 824.

As one example, the sensor array 816 is mounted in the side of the housing 812, and is utilized to obtain the range information and other information regarding locations and/or a count of the number of viewers. The sensor array 816 includes one or more transceivers 818 (denoted in FIG. 8 as UL1-UL4). The transceivers 818 may be implemented with a variety of transceiver configuration that perform range determinations. Each of the transceivers 818 may be utilized to both transmit and receive acoustic signals. Alternatively, one or more individual transceivers 818 (e.g. UL1) may be designated as a dedicated omnidirectional transmitter, one or more of the remaining transceivers 818 (e.g. UL2-4) may be designated as dedicated receivers. When using a dedicated transmitter and dedicated receivers, the acoustic data collector 820 may perform parallel processing in connection with transmit and receive, even while generating multiple receive beams which may increase a speed at which the display device 824 may collect acoustic data and convert the acoustic data into position data.

Alternatively, the sensor array 816 may be implemented with transceivers 818 that perform both transmit and receive operations. Arrays 816 that utilize transceivers 818 for both transmit and receive operations are generally able to remove more background noise and exhibit higher transmit powers. The sensor array 816 may be configured to focus one or more select transmit beams along select firing lines within the field of view. The sensor array 816 may also be configured to focus one or more receive beams along select receive or reception lines within the field of view. When using multiple focused transmit beams and/or focused receive beams, the sensor array 816 will utilize lower power and collect less noise, as compared to at least some other transmit and receive configurations. When using multiple focused transmit beams and/or multiple focused receive beams, the transmit and/or receive beams are steered and swept across the scene 826 to collect acoustic data for different regions that can be converted to range information at multiple points or sub-regions over the field of view. The range information is then associated with individual viewers and utilized as viewing distances.

The transceivers 818 are electrically and communicatively coupled to a beam former in the acoustic data collection unit 820. The transceiver 818 is mounted in a common side of the housing 812 and is directed/oriented to have a common viewing direction, namely a field of view that is common and overlapping. The beam former directs the sensor array 816 to transmit acoustic beams that propagate as acoustic waves (denoted at 825) toward the scene 826 within the field of view. The sensor array 816 receives acoustic echoes or reflections from individuals 828 within the scene 826.

The beam former processes the acoustic echoes/reflections to generate acoustic data. The acoustic data represents information regarding distances between a reference point (e.g., the display device 824) and the viewers 828 in the scene 826. As explained below in more detail, in response to execution of program instructions stored in the memory 806, the processor 804 processes the acoustic data to designate range(s) in connection with the viewers 828 in the scene 826. The range(s) are designated based on the acoustic data collected by the acoustic data collector 820. The processor 804 uses the range(s) as viewing distances regarding distances between the display device 824 and individual viewers 828 in the scene.

In the example of FIG. 8, the acoustic transceivers 818 are arranged along one edge of the housing 812. For example, the acoustic transceivers 818 may be arranged along an upper edge adjacent to the lens 814. As one example, the acoustic transceivers 818 may be provided in the bezel of a television, smart phone, notebook device, tablet device and the like. The sensor array 816 may be configured to have various fields of view and ranges. For example, the sensor array 816 may be provided with a 60° field of view centered about a line extending perpendicular to the center of the sensor array 816. As another example, the field of view of the sensor array 816 may extend 5-20°, or preferably 5-35°, to either side of an axis extending perpendicular to the center of the sensor array 816 (corresponding to surface of the housing 812).

The sensor array 816 may transmit and receive at acoustic frequencies of up to about 800 KHz, or approximately between 30-100 KHz, or approximately between 40-60 KHz. The sensor array 816 may measure various ranges or distances from the lens 814. The sensor array 816 may have an operating far field range/distance of up to 20 feet, 30 feet or more. In other words, the sensor array 816 may be able to provide acoustic data (useful in updating the image data as explained herein) indicative of distance to objects of interest that are as far away as the noted ranges/distances.

The system may calibrate the acoustic data collector 820 and the camera unit 810 to a common reference coordinate system in order that acoustic data collected within the field of view can be utilized to assign ranges to individual pixels within the image data collected by the camera unit 810. The calibration may be performed through mechanical design or may be adjusted initially or periodically, such as in connection with configuration measurements. For example, a viewer may stand in the field of view at a known reference point or a known distance from the lens 814/array 816. The camera unit 810 then obtains an image data frame of the phantom and the acoustic data collector 820 obtains acoustic data indicative of distances to the objects in the phantom. The calibration image data frame and calibration acoustic data are analyzed to calibrate the acoustic data collector 820. FIG. 8 illustrates a reference coordinate system 809 to which the camera unit 810 and acoustic data collector 820 may be calibrated. When image data is captured, the resulting image data frames are stored relative to the reference coordinate system 809.

Optionally, the viewer based data rate may be set based on network utilization. For example, a threshold may be set for a select level of network utilization. The processor(s) at the content provider and/or display control device may monitor the network utilization, such as by determining an amount of bandwidth being used. The viewer based data rate may be utilized when the network utilization exceeds the threshold. For example, a viewer based data rate may be determined (e.g. continuously, at start up or at the beginning of a program), but not utilized unless or until the network utilization exceeds the threshold. Optionally, the network utilization may be entered by a user at the display control device, or determined via communication with a router/modem, or during off-hour speed tests. Optionally, the viewer based data rate may only be used during time periods in which a network charges connection fees.

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage(s) having computer (device) readable program code embodied thereon.

Any combination of one or more non-signal computer (device) readable medium(s) may be utilized. The non-signal medium may be a storage. A storage may be, for example, an electronic, magnetic, optical, electromagnetic, infrared, or semiconductor system, apparatus, or device, or any suitable combination of the foregoing. More specific examples of a storage would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified. The program instructions may also be stored in a device readable medium that can direct a device to function in a particular manner, such that the instructions stored in the device readable medium produce an article of manufacture including instructions which implement the function/act specified. The program instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the modules/controllers herein may represent circuit modules that may be implemented as hardware with associated instructions (for example, software stored on a tangible and non-transitory computer readable storage, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A device, comprising:
a processor;
a display having one or more display attributes including a display size parameter, the display having a resolution upper limit;
a sensor to determine a viewer characteristic of interest (COI) indicative of a relation between a viewer and the display;
a local storage that stores program instructions accessible by the processor;
wherein, responsive to execution of the program instructions, the processor:
manages a viewer based data rate based on the viewer COI and the one or more display attributes, the viewer based data rate representing a rate at which video content is conveyed to the display, the viewer based data rate corresponding to a discernible resolution.

2. The device of claim 1, wherein the sensor comprises a camera that collects image frame data.

3. The device of claim 1, wherein the display comprises a television and the discernible resolution corresponds to a resolution at which the video content is displayed on the television.

4. The device of claim 1, wherein the processor sets the discernible resolution to be less than the resolution upper limit of the display.

5. The device of claim 1, wherein the display, processor, local storage and sensor are held in a common housing, the sensor located adjacent the display on a front face of the housing.

6. The device of claim 1, wherein the processor, sensor and local storage comprise a video control device connected to the display, the video control device communicating with a content provider over a delivery network to manage the viewer based data rate.

7. A method, comprising: determining a viewer characteristic of interest (COI) utilizing one or more processors and a sensor, the viewer COI indicative of a relation between a viewer and a display; and
managing a viewer based data rate, utilizing one or more processors, based on the viewer COI and one or more display attributes, the viewer based data rate representing a rate at which video content is conveyed to a display, the viewer based data rate corresponding to a discernible resolution.

8. The method of claim 7, wherein the discernible resolution is less than a display resolution upper limit.

9. The method of claim 7, further comprising determining a viewing distance to a viewer as the viewer COI, wherein the managing further comprises setting the viewer based data rate based on the viewing distance and a display size parameter.

10. The method of claim 7, wherein the sensor, wherein the determining includes:
capturing image frame data representing a viewer's face;
detecting eye movement from the image frame data; and
calculating, utilizing one or more processors, gaze direction vectors from the eye movement.

11. The method of claim 7, wherein the. managing changes the viewer based data rate from a first viewer based data rate to a second viewer based data rate based on a distance to the viewer changing from a first distance to a second distance, the first viewer based data rate corresponding to a higher discernible resolution than associated with the second viewer based data rate, the first distance being shorter than the second distance.

12. The method of claim 7, further comprising, designating the viewer from a group of viewers who are located proximate to a reference point, the viewer being designated representing the closest viewer to the reference point from the group of viewers.

13. The method of claim 7, wherein the determining further comprises identifying non-viewers located proximate to a reference point.

14. The method of claim 7, further comprising:
streaming the video content over a network;
determining a network utilization associated with the network; and
performing the managing in response to the network utilization exceeding a threshold.

15. The method of claim 7, wherein the determining includes tracking movement of the viewer relative to a reference point.

16. The method of claim 7, wherein the managing reduces the viewer based data rate in connection with the viewer leaving a room.

17. The method of claim 7, wherein the managing comprises suspending delivery of the video content over a network in response to detecting a viewer leaving a room.

18. A computer program product comprising a non-signal computer readable storage comprising computer executable code to perform:
accessing one or more display attributes, the one or more display attributes including a display resolution upper limit and a display size parameter;
determining a viewer characteristic of interest (COI) utilizing one or more processors and a sensor, the viewer COI indicative of a relation between a viewer and a display; and
managing a viewer based data rate, utilizing one or more processors, based on the viewer COI and the one or more display attributes, the viewer based data rate representing a rate at which video content is conveyed to a display, the viewer based data rate corresponding to a discernible resolution.

19. The computer program product of claim 17, further comprising code to access a resolution map defining a relation between display size parameter, viewing distance and discernible resolution, the discernible resolution being determined by applying the viewer COI and display attributes to the resolution map.

20. The computer program product of claim 17, wherein the determining includes one or more of:
identifying non-viewers based on one or more distinguishing characteristics; and ignoring non-viewers in connection with determining the viewer COI.
